(19) United States
(12) Patent Application Publication
(10) Pub. No.: US 2025/0203629 A1
(43) Pub. Date: Jun. 19, 2025

(54) DYNAMIC SWITCHING BETWEEN SINGLE-TRP AND MULTI-TRP BASED PUSCH SCHEMES

(71) Applicant: Lenovo (Beijing) Limited, Beijing (CN)

(72) Inventors: Bingchao Liu, Beijing (CN); Chenxi Zhu, Beijing (CN); Lingling Xiao, Beijing (CN); Wei Ling, Beijing (CN); Yi Zhang, Beijing (CN)

(73) Assignee: Lenovo (Beijing) Limited, Beijing (CN)

(21) Appl. No.: 18/844,302

(22) PCT Filed: Apr. 29, 2022
(86) PCT No.: PCT/CN2022/090202

§ 371 Date: Sep. 5, 2024

(51) Int. Cl. H04W 72/232; H04L 5/00; H04W 72/1268; H04W 76/20

(52) U.S. Cl. CPC H04W 72/232; H04L 5/0051; H04W 72/1268; H04W 76/20

(57) ABSTRACT

Methods and apparatuses for dynamic switching between single-TRP and multi-TRP based PUSCH schemes are disclosed. In one embodiment, a UE comprises a transceiver; and a processor coupled to the transceiver, wherein the processor is configured to receive, via the transceiver, a higher layer parameter to indicate the multi-panel/TRP PUSCH scheme, a configuration of one or two SRS resource sets for CB or nCB in a BWP of a cell, and a DCI scheduling a PUSCH transmission, wherein, the one or two SRS resource sets are associated with a first UL TCI state and a second UL TCI state; and determine UL TCI state(s) applied to the scheduled PUSCH transmission according to the higher layer parameter and fields contained in the DCI, depending on the configuration of one or two SRS resource sets for CB or nCB.

### FIELD

The subject matter disclosed herein generally relates to wireless communications, and more particularly relates to methods and apparatuses for dynamic switching between single-TRP and multi-TRP based PUSCH schemes.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), transmission reception point (TRP), codebook (CB), non-codebook (nCB), Sounding Reference Signal (SRS), Physical Uplink Shared Channel (PUSCH), band width part (BWP), Downlink Control Information (DCI), Space Division Multiplexing (SDM), Frequency Division Multiplexing (FDM), Transmission Configuration Indicator (TCI), Reference Signal (RS), SRS resource indicator (SRI), SRS resource set indicator (SRSI), Code Division Multiplexing (CDM), Demodulation Reference Signal (DMRS), transport block (TB), Most Significant Bit (MSB), Least Significant Bit (LSB), Channel State Information Reference Signal (CSI-RS).

Single-TRP based UL transmission, which can be codebook (CB) based or non-codebook (nCB) based, was specified in NR Release 15, where one SRS resource set used for CB or nCB based PUSCH is configured for a BWP of a cell for a UE.

Single-DCI multi-TRP based UL transmission with repetition was specified in NR Release 17, where one TRP may send a DCI scheduling multiple PUSCH transmissions transmitted to different TRPs using different time resources. The UE can only transmit a PUSCH in a time instant from a single panel with a single TX beam.

In addition, in a scenario of single DCI based multi-TRP operation with simultaneous multi-panel UL transmission, one TRP may send a DCI scheduling one PUSCH transmitted from two UE panels with different TX beams to different TRPs. SDM or FDM based schemes can be considered.

One potential issue is how to support dynamic switching between different UL transmission schemes. For example, it is necessary to identify whether the scheduled PUSCH transmission is a single-TRP based UL transmission or a multi-TRP based UL transmission in different scenarios.

This disclosure targets dynamic switching between different UL transmission schemes considering potential simultaneous multi-panel UL transmission.

### BRIEF SUMMARY

Methods and apparatuses for dynamic switching between single-TRP and multi-TRP based PUSCH schemes are disclosed.

In one embodiment, a UE comprises a transceiver; and a processor coupled to the transceiver, wherein the processor is configured to receive, via the transceiver, a higher layer parameter to indicate the multi-panel/TRP PUSCH scheme, a configuration of one or two SRS resource sets for CB or nCB in a BWP of a cell, and a DCI scheduling a PUSCH transmission, wherein, the one or two SRS resource sets are associated with a first UL TCI state and a second UL TCI state; and determine UL TCI state(s) applied to the scheduled PUSCH transmission according to the higher layer parameter and fields contained in the DCI, depending on the configuration of one or two SRS resource sets for CB or nCB.

In some embodiment, if the configuration is two SRS resource sets for CB or nCB, and the two SRS resource sets include a first SRS resource set associated with a first UL TCI state and a second SRS resource set associated with a second UL TCI state, then, an SRS resource set indicator (SRSI) field contained in the DCI determines the scheduled PUSCH transmission is a single-panel/TRP PUSCH transmission or a multi-panel/TRP PUSCH transmission. If a field value of the SRSI field is ‘00’ or ‘01’, the scheduled PUSCH transmission is a single-panel/TRP PUSCH transmission. In particular, if the field value of the SRSI field is ‘00’, the first UL TCI state is applied to the scheduled PUSCH transmission, and if the field value of the SRSI field is ‘01’, the second UL TCI state is applied to the scheduled PUSCH transmission. If a field value of the SRSI field is ‘10’ or ‘11’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of the SRSI field is ‘10’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the SRSI field is ‘11’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the SRSI field is ‘10’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the SRSI field is ‘11’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the SRSI field is ‘10’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the SRSI field is ‘11’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then, a PUSCH scheme field contained in the DCI determines the scheduled PUSCH transmission is a single-panel/TRP PUSCH transmission or a multi-panel/TRP PUSCH transmission. If a field value of the PUSCH scheme field is ‘0’, the scheduled PUSCH transmission is a single-panel/TRP PUSCH transmission. In particular, if the field value of a 1-bit SRI field is ‘0’, the first UL TCI state is applied to the scheduled PUSCH transmission, and if the field value of the 1-bit SRI field is ‘1’, the second UL TCI state is applied to the scheduled PUSCH transmission. If a field value of the PUSCH scheme field is ‘1’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of a 1-bit SRI field is ‘0’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the 1-bit SRI field is ‘1’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the 1-bit SRI field is ‘0’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the 1-bit SRI field is ‘1’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the 1-bit SRI field is ‘0’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the 1-bit SRI field is ‘1’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then, an 8-bit SRI field contained in the DCI determines the scheduled PUSCH transmission is a single-panel/TRP PUSCH transmission or a multi-panel/TRP PUSCH transmission. If the SRS resource(s) indicated by the 8-bit SRI field are only from the first half or the second half, the scheduled PUSCH transmission is a single-panel/TRP PUSCH transmission. In particular, if the indicated SRS resource(s) are only from the first half, the first UL TCI state is applied to the scheduled PUSCH transmission, and if the indicated SRS resource(s) are only from the second half, the second UL TCI state is applied to the scheduled PUSCH transmission. If the SRS resources indicated by the 8-bit SRI field are from both the first half and the second half, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, (2) if the higher layer parameter is configured as is set as ‘sdmSchemeA’, then, the first UL TCI state is applied to a first PUSCH transmission occasion associated with the indicated SRS resource(s) from the first half, and the second UL TCI state is applied to a second PUSCH transmission occasion associated with the indicated SRS resource(s) from the second half, (3) if the ‘antenna port(s)’ field of the DCI indicates only DMRS port(s) within the first CDM group, and the higher layer parameter is configured as is set as ‘fdmSchemeA’, then, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and (4) if the ‘antenna port(s)’ field of the DCI indicates only DMRS port(s) within the first CDM group, the higher layer parameter is configured as is set as ‘fdmSchemeB’, then, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation.

In another embodiment, a method performed at a UE comprises receiving a higher layer parameter to indicate the multi-panel/TRP PUSCH scheme, a configuration of one or two SRS resource sets for CB or nCB in a BWP of a cell, and a DCI scheduling a PUSCH transmission, wherein, the one or two SRS resource sets are associated with a first UL TCI state and a second UL TCI state; and determining UL TCI state(s) applied to the scheduled PUSCH transmission according to the higher layer parameter and fields contained in the DCI, depending on the configuration of one or two SRS resource sets for CB or nCB.

In still another embodiment, a base unit comprises a transceiver; and a processor coupled to the transceiver, wherein the processor is configured to transmit, via the transceiver, a higher layer parameter to indicate the multi-panel/TRP PUSCH scheme and a configuration of one or two SRS resource sets for CB or nCB, wherein, the one or two SRS resource sets are associated with a first UL TCI state and a second UL TCI state; determine UL TCI state(s) applied to a PUSCH transmission according to the preconfigured higher layer parameter, depending on the configuration; and transmit, via the transceiver, a DCI scheduling the PUSCH transmission, wherein, the DCI contains fields for indicating the determined UL TCI state(s).

In some embodiment, if the configuration is two SRS resource sets for CB or nCB, and the two SRS resource sets include a first SRS resource set associated with a first UL TCI state and a second SRS resource set associated with a second UL TCI state, then, an SRS resource set indicator (SRSI) field contained in the DCI determines the scheduled PUSCH transmission is a single-panel/TRP PUSCH transmission or a multi-panel/TRP PUSCH transmission. If a field value of the SRSI field is ‘00’ or ‘01’, the scheduled PUSCH transmission is a single-panel/TRP PUSCH transmission. In particular, if the field value of the SRSI field is ‘00’, the first UL TCI state is applied to the scheduled PUSCH transmission, and if the field value of the SRSI field is ‘01’, the second UL TCI state is applied to the scheduled PUSCH transmission. If a field value of the SRSI field is ‘10’ or ‘11’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of the SRSI field is ‘10’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the SRSI field is ‘11’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the SRSI field is ‘10’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the SRSI field is ‘11’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the SRSI field is ‘10’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the SRSI field is ‘11’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then, a PUSCH scheme field contained in the DCI determines the scheduled PUSCH transmission is a single-panel/TRP PUSCH transmission or a multi-panel/TRP PUSCH transmission. If a field value of the PUSCH scheme field is ‘0’, the scheduled PUSCH transmission is a single-panel/TRP PUSCH transmission. In particular, if the field value of a 1-bit SRI field is ‘0’, the first UL TCI state is applied to the scheduled PUSCH transmission, and if the field value of the 1-bit SRI field is ‘1’, the second UL TCI state is applied to the scheduled PUSCH transmission. If a field value of the PUSCH scheme field is ‘1’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of a 1-bit SRI field is ‘0’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the 1-bit SRI field is ‘1’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the 1-bit SRI field is ‘0’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the 1-bit SRI field is ‘1’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the 1-bit SRI field is ‘0’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the 1-bit SRI field is ‘1’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then, an 8-bit SRI field contained in the DCI determines the scheduled PUSCH transmission is a single-panel/TRP PUSCH transmission or a multi-panel/TRP PUSCH transmission. If the SRS resource(s) indicated by the 8-bit SRI field are only from the first half or the second half, the scheduled PUSCH transmission is a single-panel/TRP PUSCH transmission. In particular, if the indicated SRS resource(s) are only from the first half, the first UL TCI state is applied to the scheduled PUSCH transmission, and if the indicated SRS resource(s) are only from the second half, the second UL TCI state is applied to the scheduled PUSCH transmission. If the SRS resources indicated by the 8-bit SRI field are from both the first half and the second half, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, (2) if the higher layer parameter is configured as is set as ‘sdmSchemeA’, then, the first UL TCI state is applied to a first PUSCH transmission occasion associated with the indicated SRS resource(s) from the first half, and the second UL TCI state is applied to a second PUSCH transmission occasion associated with the indicated SRS resource(s) from the second half, (3) if the ‘antenna port(s)’ field of the DCI indicates only DMRS port(s) within the first CDM group, and the higher layer parameter is configured as is set as ‘fdmSchemeA’, then, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and (4) if the ‘antenna port(s)’ field of the DCI indicates only DMRS port(s) within the first CDM group, the higher layer parameter is configured as is set as ‘fdmSchemeB’, then, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation.

In yet another embodiment, a method performed at a base unit comprises transmitting a higher layer parameter to indicate the multi-panel/TRP PUSCH scheme and a configuration of one or two SRS resource sets for CB or nCB, wherein, the one or two SRS resource sets are associated with a first UL TCI state and a second UL TCI state; determining UL TCI state(s) applied to a PUSCH transmission according to the preconfigured higher layer parameter, depending on the configuration; and transmitting a DCI scheduling the PUSCH transmission, wherein, the DCI contains fields for indicating the determined UL TCI state(s).

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a summary of the first embodiment;

FIG. 2 illustrates a summary of the first embodiment;

FIG. 3 is a schematic flow chart diagram illustrating an embodiment of a method;

FIG. 4 is a schematic flow chart diagram illustrating an embodiment of another method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

“Multi-TRP” means that a serving cell can have multiple (e.g. two) TRPs. “Multi-panel” means that a UE can have multiple (e.g. two) panels at least for UL transmission. In the condition that a UE equipped with two panels (e.g. panel #0 and panel #1) transmits UL signal (e.g. PUSCH transmissions) to a serving cell with two TRPs (e.g. TRP #0 and TRP #1), the UE may use one panel (e.g. panel #0) to transmit UL signal to one TRP (e.g. TRP #0) of the serving cell and use the other panel (e.g. panel #1) to transmit UL signal to another TRP (e.g. TRP #1) of the serving cell. So, one panel is associated with one TRP. For example, panel #0 is associated with TRP #0, and panel #1 is associated with TRP #1. So, multi-panel multi-TRP scenario can be described as multi-panel/TRP.

“Multi-panel/TRP simultaneous UL transmission” means the UE transmit UL signals from multiple panels (e.g. two panels) to multiple TRPs (e.g. two TRPs) simultaneously.

Two UL or joint TCI states are activated or indicated by a single TCI codepoint for UL signal (e.g. PUSCH transmission) transmitted from two panels to two TRPs for one BWP of a cell if unified TCI framework is configured. UL TCI state is indicated when separate DL/UL TCI framework is configured, where the Tx beam for UL transmit and the Rx beam for DL reception are separately indicated by UL TCI state and DL TCI state, respectively. Each UL TCI state indicates a DL RS or an SRS for the UE to determine the TX spatial filter, i.e., the TX beam, for UL transmission. Joint TCI state is indicated when joint DL/UL TCI framework is configured, where both Tx beam for UL transmission and Rx beam for DL reception are determined by the indicated joint TCI state. Each joint TCI state indicates a DL RS for the UE to determine the TX spatial filter for UL transmission, and the RX spatial filter for DL reception. For ease of discussion, in the following description, the indicated two UL or joint TCI states are referred to as the two UL TCI states, or more specifically, a first UL TCI state and a second UL TCI state.

The panel can be identified by SRS resources or SRS resource sets, each of which consists one or multiple SRS resources, configured to the UE.

One or two SRS resource sets can be configured to the UE in a BWP of a cell used for CB or nCB based PUSCH transmission.

The UE can be configured in two different modes for PUSCH multi-antenna precoding, referred as codebook (CB) based transmission and non-codebook (nCB) based transmission, respectively. When the UE is configured with codebook based PUSCH transmission, one or two SRS resource sets used for codebook can be configured in a BWP of a cell for the UE. When the UE is configured with non-codebook based PUSCH transmission, one or two SRS resource sets used for non-codebook can be configured in a BWP of a cell for the UE. To enable codebook based PUSCH transmission, the UE shall be configured to transmit one or more SRS resources used for codebook for channel measurement. Based on the measurements on the configured SRS resources, the gNB determines a suitable rank and the precoding matrix from a pre-defined codebook, which includes a set of precoding matrices with different ranks, and sends the information to the UE.

For non-codebook based PUSCH transmission, the UE is required to measure a CSI-RS to obtain the channel information based channel reciprocity. The UE selects what it believes is a suitable uplink precoder and applies the selected precoder to a set of configured SRS resources with one SRS resource being transmitted on each layer defined by the precoder. Based on the received SRS resources, the gNB decides to modify the UE-selected precoder for the scheduled PUSCH transmission.

If the UE reports a capability to support simultaneous multi-panel UL transmission, two SRS resource sets (e.g. a first SRS resource set and a second SRS resource set) for CB or nCB can be configured in a BWP of a cell, where the same antenna port number is configured for each SRS resource within each SRS resource set when full Tx Power mode is not configured. In this situation, two SRI fields (e.g. a first SRI field and a second SRI field) are contained in the scheduling DCI with format 0_1 or 0_2, where each SRI field indicates one or more SRS resources within an SRS resource set.

When two SRS resource sets (e.g. a first SRS resource set and a second SRS resource set) for CB or nCB are configured to the UE, a first panel corresponds to the first SRS resource set, and a second panel corresponds to the second SRS resource set. The first UL TCI state is applied to the first SRS resource set, and the second UL TCI state is applied to the second SRS resource set. So, the first panel also corresponds to the first UL TCI state, and the second panel also corresponds to the second UL TCI state.

The capability to support simultaneous multi-panel UL transmission can be reported by whether to support simultaneously transmit UL signals with different UL TCI states. If a UE reports to support simultaneously transmit UL signals with different UL TCI states, simultaneous multi-panel UL transmission is supported by the UE. If a UE reports that it does not support simultaneously transmit UL signals with different UL TCI states, simultaneous multi-panel UL transmission is not supported by the UE.

For CB based PUSCH, two SRS resources (i.e. a first SRS resource and a second SRS resource) or four SRS resources (i.e. first two SRS resources and last two SRS resources) are included in the one SRS resource set for CB. So, the first panel corresponds to the first SRS resource or the first two SRS resources, and the second panel corresponds to the second SRS resource or the last two SRS resources. The first UL TCI state is applied to the first SRS resource or the first two SRS resources, and the second UL TCI state is applied to the second SRS resource or the last two SRS resources. So, the first panel also corresponds to the first UL TCI state, and the second panel also corresponds to the second UL TCI state.

For nCB based PUSCH, up to 8 SRS resources can be configured in the one SRS resource set for nCB. So, the first panel corresponds to a first half of the configured SRS resources in the one SRS resource set for nCB, and the second panel corresponds to a second half of the configured SRS resources in the one SRS resource set for nCB. The first UL TCI state applies to the first half of the configured SRS resources in the one SRS resource set for nCB, and the second UL TCI state applies to the second half of the configured SRS resources in the one SRS resource set for nCB. So, the first panel corresponds to the first UL TCI state, and the second panel corresponds to the second UL TCI state.

A DCI (e.g. DCI with format 0_1 or 0_2) can schedule a single-TRP PUSCH transmission (which means that the scheduled PUSCH transmission is to be transmitted from only one panel to one TRP) or a multi-TRP PUSCH transmission (which means that the scheduled PUSCH transmission is to be transmitted from two panels to two TRPs, where the transmission from each panel is transmitted to a different TRP, e.g. from panel #0 to TRP #0 and from panel #1 and TRP #1). In addition, the multi-TRP PUSCH transmission can be based on FDM scheme (e.g. FDM scheme A or FDM scheme B) or SDM scheme (e.g. SDM scheme 1 or SDM scheme 2).

A first embodiment relates to dynamic switching between single-TRP based PUSCH scheme and multi-TRP based PUSCH scheme (i.e. identify which of the single-TRP PUSCH transmission and the multi-TRP PUSCH transmission is scheduled) when two SRS resource sets for CB or nCB are configured in a BWP of a cell.

A PUSCH transmission is scheduled by a DCI with format 0_1 or 0_2 (which may be referred to as scheduling DCI). Two SRI fields (e.g. a first SRI field and a second SRI field) and an “antenna port(s)” field are included in the scheduling DCI.

According to the first embodiment, an SRS resource set indicator (SRSI) field is introduced in the scheduling DCI to identify single-TRP PUSCH transmission or multi-TRP PUSCH transmission.

The SRSI field has two bits, and the field value (or codepoint) of the SRSI field can be ‘00’, ‘01’, ‘10’ or ‘11’.

When the field value of the SRSI field is ‘00’ or ‘01’, single-TRP based PUSCH scheme is determined. It means that single-TRP PUSCH transmission is scheduled, i.e., the scheduled PUSCH transmission is transmitted by a single panel.

In particular, when the field value of the SRSI field is ‘00’, the first SRI field indicates one or more SRS resources within the first SRS resource set, and the second SRI field is reserved. The first UL TCI state is applied to the scheduled PUSCH transmission, which means that the PUSCH transmission is scheduled to be transmitted by using the first UL TCI state.

When the field value of the SRSI field is ‘01’, the first SRI field indicates one or more SRS resources within the second SRS resource set, and the second SRI field is reserved. The second UL TCI state is applied to the scheduled PUSCH transmission.

It can be seen that when the SRSI field in the scheduling DCI is ‘00’ or ‘01’, only one of the first UL TCI state and the second UL TCI state is applied to the scheduled PUSCH transmission.

When the field value of the SRSI field is ‘10’ or ‘11’, multi-panel/TRP based PUSCH scheme is determined. It means that the scheduled PUSCH transmission is transmitted by using both the first UL TCI state and the second UL TCI state. So, when the SRSI field in the scheduling DCI is ‘10’ or ‘11’, both the first UL TCI state and the second UL TCI state are used. When multi-panel/TRP based PUSCH scheme is determined, which UL TCI state (e.g. the first UL TCI state or the second UL TCI state) is applied to the scheduled PUSCH transmission transmitted from the first panel and the second panel is further determined according to the scheduling DCI and a higher layer parameter repetitionScheme configured in the PUSCH Configuration for the UE in a BWP of a cell to indicate the multi-TRP PUSCH scheme

In the scheduling DCI, the first SRI field indicates one or more SRS resources within the first SRS resource set and the second SRI field indicates one or more SRS resources within the second SRS resource set.

The ‘antenna port(s)’ field in the scheduling DCI and a higher layer parameter repetitionScheme in the PUSCH Configuration determine the multi-TRP PUSCH scheme (e.g. SDM scheme 1 or SDM scheme 2 or FDM scheme A or FDM scheme B).

### SDM Scheme 1:

When repetitionScheme is not configured or repetitionScheme is configured and is set as ‘fdmSchemeA’ or ‘fdmSchemeB’ and the ‘antenna port(s)’ field indicates two CDM groups, SDM scheme 1 is determined.

Two DMRS types named DMRS type 1 and DMRS type 2 are specified in NR Release 15. Up to 8 DMRS ports, i.e., DMRS ports 0, 1, . . . , 7 are supported for DMRS type 1. DMRS ports 0, 1, 4 and 5 belong to CDM group 0 and DMRS ports 2, 3, 6 and 7 belong to CDM group 1. Up to 12 DMRS ports, i.e., DMRS ports 0, 1, . . . , 11 are supported for DMRS type 2. DMRS ports 0, 1, 6 and 7 belong to CDM group 0, DMRS ports 2, 3, 8 and 9 belong to CDM group 1, and DMRS ports 4, 5, 10 and 11 belong to CDM group 2.

The ‘antenna port(s)’ field in the scheduling DCI indicates a number of DMRS ports (selected from 8 DMRS ports when DMRS type 1 is configured or selected from 12 DMRS ports when DMRS type 2 is configured) each of which is associated with one PUSCH layer. It means that the number of the indicated DMRS ports is equal to the number of PUSCH layers of the scheduled PUSCH transmission. Each PUSCH layer is associated with an indicated DMRS port. The CDM group (e.g. either of CDM group 0 or CDM group 1 when DMRS type 1 is configured, or either of CDM group 0 or CDM group 1 or CDM group 2 when DMRS type 2 is configured) containing the first indicated DMRS port is the first CDM group. If all of the indicated DMRS ports belong to the first CDM group, it means that the ‘antenna port(s)’ field in the scheduling DCI indicates one CDM group. If any of the indicated DMRS ports (other than the first indicated DMRS port) belongs to another CDM group different from the first CDM group including the first indicated DMRS port, it means that the ‘antenna port(s)’ field in the scheduling DCI indicates two CDM groups: the first CDM group and a second CDM group.

For SDM scheme 1, different PUSCH layers of the scheduled PUSCH transmission are transmitted by different panels. It means that some PUSCH layer(s) are transmitted by the first panel and the other PUSCH layer(s) are transmitted by the second panel. The PUSCH layer(s) to be transmitted by the first panel are the PUSCH layer(s) each of which is associated with an indicated DMRS port within the first CDM group (which contains the first DMRS port indicated by the ‘antenna port(s)’ field), and the PUSCH layer(s) to be transmitted by the second panel are the PUSCH layer(s) each of which is associated an indicated DMRS port within the second CDM group (i.e. the other CDM group than the first CDM group).

If the field value of the SRSI field is ‘10’ and the SDM scheme 1 is determined, the first UL TCI state is applied to the PUSCH layer(s) each of which is associated with an indicated DMRS port within the first CDM group, and the second UL TCI state is applied to the PUSCH layer(s) each of which is associated with an indicated DMRS port within the second CDM group.

If the field value of the SRSI field is ‘11’ and the SDM scheme 1 is determined, the second UL TCI state is applied to the PUSCH layer(s) each of which is associated with an indicated DMRS port belonging to the first CDM group, and the first UL TCI state is applied to the PUSCH layer(s) each of which is associated with an indicated DMRS port belonging to the second CDM group.

### SDM Scheme 2:

When repetitionScheme is configured and is set as ‘sdmSchemeA’, and the ‘antenna port(s)’ field indicates one CDM group or two CDM groups, SDM scheme 2 is determined.

For SDM scheme 2, the UE shall transmit two PUSCH transmission occasions (e.g. a first PUSCH transmission occasion and a second PUSCH transmission occasion, which are the same) of a same TB. Each of the two PUSCH transmission occasions has the same number of PUSCH layer(s) and the same time-frequency resources, which means that the same number of PUSCH layer(s) with the same time-frequency resources is simultaneously transmitted by using the first panel and transmitted by using the second panel.

If the field value of the SRSI field is ‘10’ or ‘11’ and the SDM scheme 2 is determined, both the two UL TCJ states (i.e. both the first UL TCJ state and the second UL TCJ state) are applied to the scheduled PUSCH transmission. It means that the first PUSCH transmission occasion is transmitted by using the first UL TCJ state, and the second PUSCH transmission occasion is transmitted by using the second UL TCJ state, where the first PUSCH transmission occasion and the second PUSCH transmission occasion have the same number of PUSCH layer(s) and the same time-frequency resources.

### FDM Scheme A:

When repetitionScheme is configured and is set as ‘fdmSchemeA’ and the ‘antenna port(s)’ field indicates one CDM group, FDM scheme A is determined.

For FDM scheme A, the UE shall transmit a single PUSCH transmission occasion of a TB. That is, the single (or one) PUSCH transmission occasion is mapped to two non-overlapping frequency domain resource allocations (e.g. a first frequency domain resource allocation of the one PUSCH transmission occasion and a second frequency domain resource allocation of the one PUSCH transmission occasion) corresponding to two panels associated with different UL TCJ states.

If the field value of the SRSI field is ‘10’ and the FDM scheme A is determined, the first UL TCJ state is applied to the first frequency domain resource allocation of the one PUSCH transmission occasion, and the second UL TCJ state is applied to the second frequency domain resource allocation of the one PUSCH transmission occasion.

If the field value of the SRSI field is ‘11’ and the FDM scheme A is determined, the first UL TCI state is applied to the second frequency domain resource allocation of the one PUSCH transmission occasion, and the second UL TCI state is applied to the first frequency domain resource allocation of the one PUSCH transmission occasion.

### FDM Scheme B:

When repetitionScheme is configured and is set as ‘fdmSchemeB’ and the ‘antenna port(s)’ field indicates one CDM group, FDM scheme B is determined.

For FDM scheme B, the UE shall transmit two PUSCH transmission occasions (e.g. a first PUSCH transmission occasion and a second PUSCH transmission occasion) of a same TB. The two PUSCH transmission occasions are mapped to two non-overlapping frequency domain resource allocations corresponding two panels associated with different UL TCI states. That is, the first PUSCH transmission occasion is mapped to a first frequency domain resource allocation for one panel, and the second PUSCH transmission occasion is mapped to a second frequency domain resource allocation for the other panel, wherein the first frequency domain resource allocation and the second frequency domain resource allocation are non-overlapping.

If the field value of the SRSI field is ‘10’ and the FDM scheme B is determined, the first UL TCI state is applied to the first PUSCH transmission occasion associated with the first frequency domain resource allocation, and the second UL TCI state is applied to the second PUSCH transmission occasion associated with the second frequency domain resource allocation.

If the field value of the SRSI field is ‘11’ and the FDM scheme B is determined, the first UL TCI state is applied to the second PUSCH transmission occasion associated with the second frequency domain resource allocation, and the second UL TCI state is applied to the first PUSCH transmission occasion associated with the first frequency domain resource allocation.

As a whole, the first embodiment can be summarized as in FIG. 1.

It can be seen from FIG. 1 that, when the field value of the SRSI field is ‘00’ or ‘01’ (i.e. single-TRP based PUSCH scheme is determined), the ‘antenna port(s)’ field can indicate one or two CDM groups, and the higher layer parameter repetitionScheme may be not configured or configured and set as ‘fdmSchemeA’ or ‘fdmSchemeB’.

A second embodiment relates to dynamic switching between single-TRP based PUSCH scheme and multi-TRP based PUSCH scheme (i.e. identify which of the single-TRP PUSCH transmission and the multi-TRP PUSCH transmission is scheduled) when one SRS resource set for CB is configured in a BWP of a cell. For CB based PUSCH transmission, the one SRS resource set contains 2 SRS resources or 4 SRS resources.

A PUSCH transmission is scheduled by a scheduling DCI. One SRI field and an “antenna port(s)” field are included in the scheduling DCI.

The SRI field has 1 bit, and the field value (or codepoint) of the SRI field can be ‘0’ or ‘1’.

According to the second embodiment, a 1-bit PUSCH scheme field is introduced in the scheduling DCI. The PUSCH scheme field has 1 bit, and the field value (or codepoint) of the PUSCH scheme field can be ‘0’ or ‘1’.

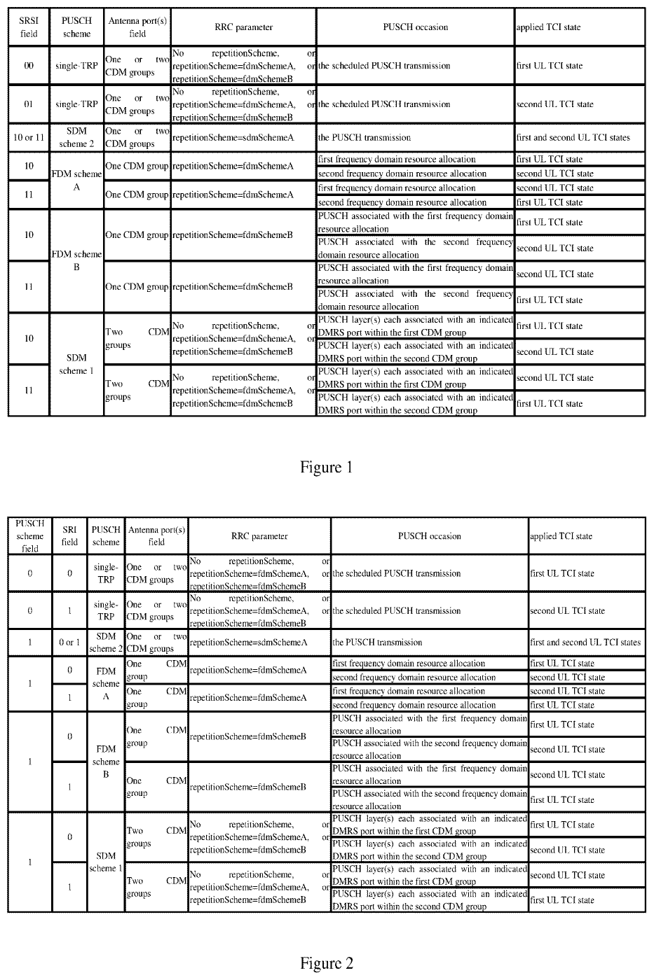

The second embodiment is summarized in FIG. 2.

A comparison between FIG. 1 and FIG. 2 can reveal that a combination of the PUSCH scheme field and the 1-bit SRI field in the second embodiment is equal to the 2-bits SRSI field in the first embodiment, while the other parts of FIG. 1 and of FIG. 2 are completely the same. In other words, a 2-bits value composed of MSB being the field value of the PUSCH scheme field and LSB being the field value of the SRI field is the same as the field value of the SRSI field.

The second embodiment can be described as follows:

(1) The PUSCH scheme field identifies single-panel/TRP PUSCH transmission (PUSCH scheme field is indicated as ‘0’) or multi-panel/TRP PUSCH transmission (PUSCH scheme field is indicated as ‘1’).

(2) The ‘antenna port(s)’ field in the scheduling DCI and a higher layer parameter repetitionScheme in the PUSCH Configuration determine the multi-panel/TRP PUSCH scheme (e.g. SDM scheme 1 or SDM scheme 2 or FDM scheme A or FDM scheme B).

(3) When single-panel/TRP PUSCH transmission is determined, the SRI field indicates which UL TCI state (which one of the first UL TCI state and the second UL TCI state) is applied to the scheduled PUSCH transmission; and when multi-panel/TRP PUSCH transmission is determined, SDM scheme 1 or SDM scheme 2 or FDM scheme A or FDM scheme B of the multi-TRP PUSCH transmission is determined according to the ‘antenna port(s)’ field and the higher layer parameter repetitionScheme, the SRI field indicates which UL TCI state is applied to which PUSCH transmission occasion or which part of the scheduled PUSCH transmission.

A third embodiment relates to dynamic switching between single-panel/TRP based PUSCH scheme and multi-panel/TRP based PUSCH scheme (i.e. identify which of the single-panel/TRP PUSCH transmission and the multi-panel/TRP PUSCH transmission is scheduled) when one SRS resource set for nCB is configured in a BWP of a cell. For nCB based PUSCH transmission, the one SRS resource set contains up to 8 SRS resources. The 8 SRS resources in the one SRS resource set can be divided into a first half and a second half.

An 8-bit SRI field is contained in the scheduling DCI format 0_1 or 0_2. The 8-bit SRI field has up to 160 different SRI field values, each of which indicates a combination of one or two or three or four SRS resources from the 8 SRS resources contained in the one SRS resource set.

If all the indicated SRS resource(s) are from the first half or the second half (of the SRS resources in the one SRS resource set), single-panel/TRP based PUSCH scheme is determined. It means that single-panel/TRP PUSCH transmission is scheduled, i.e., the scheduled PUSCH transmission is transmitted by a single panel.

In particular, if all the indicated SRS resource(s) are from the first half, the first UL TCI state is applied to the scheduled PUSCH transmission.

If all the indicated SRS resource(s) are from the second half, the second UL TCI state is applied to the scheduled PUSCH transmission.

If the indicated SRS resources are from both the first half and the second half (of the SRS resources in the SRS resource set), multi-panel/TRP based PUSCH scheme is determined. It means that the scheduled PUSCH transmission is transmitted by using both the first UL TCI state and the second UL TCI state.

If repetitionScheme is not configured or repetitionScheme is configured and is set as ‘fdmSchemeA’ or ‘fdmSchemeB’ and the ‘antenna port(s)’ field indicates two CDM groups (e.g. a first CDM group and a second CDM group), different PUSCH layers of the scheduled PUSCH transmission are transmitted by different panels. The PUSCH layer(s) to be transmitted by the first panel are the PUSCH layer(s) each of which is associated with an indicated DMRS port within the first CDM group (which contains the first DMRS port indicated by the ‘antenna port(s)’ field), and the PUSCH layer(s) to be transmitted by the second panel are the PUSCH layer(s) each of which is associated an indicated DMRS port within the second CDM group (i.e. the other CDM group than the first CDM group). The first UL TCI state is applied to the PUSCH layer(s) each of which is associated with an indicated DMRS port within the first CDM group, and the second UL TCJ state is applied to the PUSCH layer(s) each of which is associated with an indicated DMRS port within the second CDM group.

If repetitionScheme is configured and is set as ‘sdmSchemeA’, the UE shall transmit two PUSCH transmission occasions (e.g. a first PUSCH transmission occasion and a second PUSCH transmission occasion, which are the same) of a same TB, where the first PUSCH transmission occasion is associated with the indicated SRS resource(s) from the first half of the SRS resource(s) in the one SRS resource set, and the second PUSCH transmission occasion is associated with the indicated SRS resource(s) from the second half of the SRS resource(s) in the one SRS resource set. The first UL TCJ state is applied to the first PUSCH transmission occasion (associated with the indicated SRS resource(s) from the first half of the SRS resource(s) in the one SRS resource set), and the second UL TCJ state is applied to the second PUSCH transmission occasion (associated with the indicated SRS resource(s) form the second half of the SRS resource(s) in the SRS resource set).

If repetitionScheme is configured and is set as ‘fdmSchemeA’ and the ‘antenna port(s)’ field indicates one CDM group, the UE shall transmit a single PUSCH transmission occasion of a TB. That is, the single (or one) PUSCH transmission occasion is mapped to two non-overlapping frequency domain resource allocations (e.g. a first frequency domain resource allocation of the one PUSCH transmission occasion and a second frequency domain resource allocation of the one PUSCH transmission occasion) corresponding to two panels associate with different UL TCJ states. The first UL TCJ state is applied to the first frequency domain resource allocation of the one PUSCH transmission occasion, and the second UL TCJ state is applied to the second frequency domain resource allocation of the one PUSCH transmission occasion.

If repetitionScheme is configured and is set as ‘fdmSchemeB’ and the ‘antenna port(s)’ field indicates one CDM group, the UE shall transmit two PUSCH transmission occasions (e.g. a first PUSCH transmission occasion and a second PUSCH transmission occasion) of a same TB. The two PUSCH transmission occasions are mapped to two non-overlapping frequency domain resource allocations corresponding two panels associated with different UL TCI states. That is, the first PUSCH transmission occasion is mapped to a first frequency domain resource allocation for one panel, and the second PUSCH transmission occasion is mapped to a second frequency domain resource allocation for the other panel, wherein the first frequency domain resource allocation and the second frequency domain resource allocation are non-overlapping. The first UL TCI state is applied to the first PUSCH transmission occasion associated with the first frequency domain resource allocation, and the second UL TCI state is applied to the second PUSCH transmission occasion associated with the second frequency domain resource allocation.

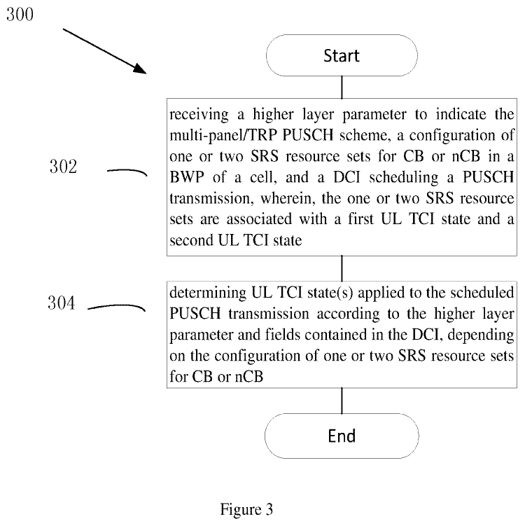

FIG. 3 is a schematic flow chart diagram illustrating an embodiment of a method 300 according to the present application. In some embodiments, the method 300 is performed by an apparatus, such as a remote unit (e.g. UE). In certain embodiments, the method 300 may be performed by a processor executing program code, for example, a microcontroller, a microprocessor, a CPU, a GPU, an auxiliary processing unit, a FPGA, or the like.

The method 300 is a method of a UE, comprising: 302 receiving a higher layer parameter to indicate the multi-panel/TRP PUSCH scheme, a configuration of one or two SRS resource sets for CB or nCB in a BWP of a cell, and a DCI scheduling a PUSCH transmission, wherein, the one or two SRS resource sets are associated with a first UL TCI state and a second UL TCI state; and 304 determining UL TCI state(s) applied to the scheduled PUSCH transmission according to the higher layer parameter and fields contained in the DCI, depending on the configuration of one or two SRS resource sets for CB or nCB.

In some embodiment, if the configuration is two SRS resource sets for CB or nCB, and the two SRS resource sets include a first SRS resource set associated with a first UL TCI state and a second SRS resource set associated with a second UL TCI state, then, an SRS resource set indicator (SRSI) field contained in the DCI determines the scheduled PUSCH transmission is a single-panel/TRP PUSCH transmission or a multi-panel/TRP PUSCH transmission. If a field value of the SRSI field is ‘00’ or ‘01’, the scheduled PUSCH transmission is a single-panel/TRP PUSCH transmission. In particular, if the field value of the SRSI field is ‘00’, the first UL TCI state is applied to the scheduled PUSCH transmission, and if the field value of the SRSI field is ‘01’, the second UL TCI state is applied to the scheduled PUSCH transmission. If a field value of the SRSI field is ‘10’ or ‘11’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of the SRSI field is ‘10’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the SRSI field is ‘11’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the SRSI field is ‘10’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the SRSI field is ‘11’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the SRSI field is ‘10’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the SRSI field is ‘11’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then, a PUSCH scheme field contained in the DCI determines the scheduled PUSCH transmission is a single-panel/TRP PUSCH transmission or a multi-panel/TRP PUSCH transmission. If a field value of the PUSCH scheme field is ‘0’, the scheduled PUSCH transmission is a single-panel/TRP PUSCH transmission. In particular, if the field value of a 1-bit SRI field is ‘0’, the first UL TCI state is applied to the scheduled PUSCH transmission, and if the field value of the 1-bit SRI field is ‘1’, the second UL TCI state is applied to the scheduled PUSCH transmission. If a field value of the PUSCH scheme field is ‘1’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of a 1-bit SRI field is ‘0’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the 1-bit SRI field is ‘1’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the 1-bit SRI field is ‘0’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the 1-bit SRI field is ‘1’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the 1-bit SRI field is ‘0’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the 1-bit SRI field is ‘1’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then, an 8-bit SRI field contained in the DCI determines the scheduled PUSCH transmission is a single-panel/TRP PUSCH transmission or a multi-panel/TRP PUSCH transmission. If the SRS resource(s) indicated by the 8-bit SRI field are only from the first half or the second half, the scheduled PUSCH transmission is a single-panel/TRP PUSCH transmission. In particular, if the indicated SRS resource(s) are only from the first half, the first UL TCI state is applied to the scheduled PUSCH transmission, and if the indicated SRS resource(s) are only from the second half, the second UL TCI state is applied to the scheduled PUSCH transmission. If the SRS resources indicated by the 8-bit SRI field are from both the first half and the second half, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, (2) if the higher layer parameter is configured as is set as ‘sdmSchemeA’, then, the first UL TCI state is applied to a first PUSCH transmission occasion associated with the indicated SRS resource(s) from the first half, and the second UL TCI state is applied to a second PUSCH transmission occasion associated with the indicated SRS resource(s) from the second half, (3) if the ‘antenna port(s)’ field of the DCI indicates only DMRS port(s) within the first CDM group, and the higher layer parameter is configured as is set as ‘fdmSchemeA’, then, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and (4) if the ‘antenna port(s)’ field of the DCI indicates only DMRS port(s) within the first CDM group, the higher layer parameter is configured as is set as ‘fdmSchemeB’, then, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation.

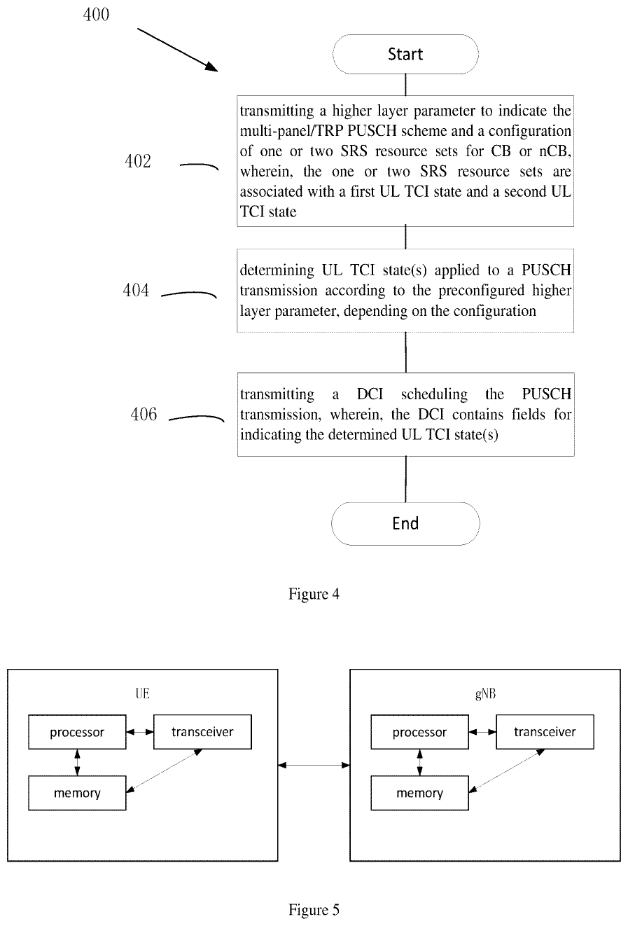

FIG. 4 is a schematic flow chart diagram illustrating an embodiment of a method 400 according to the present application. In some embodiments, the method 400 is performed by an apparatus, such as a base unit. In certain embodiments, the method 400 may be performed by a processor executing program code, for example, a microcontroller, a microprocessor, a CPU, a GPU, an auxiliary processing unit, a FPGA, or the like.

The method 400 may comprise 402 transmitting a higher layer parameter to indicate the multi-panel/TRP PUSCH scheme and a configuration of one or two SRS resource sets for CB or nCB, wherein, the one or two SRS resource sets are associated with a first UL TCI state and a second UL TCI state; 404 determining UL TCI state(s) applied to a PUSCH transmission according to the preconfigured higher layer parameter, depending on the configuration; and 406 transmitting a DCI scheduling the PUSCH transmission, wherein, the DCI contains fields for indicating the determined UL TCI state(s).

In some embodiment, if the configuration is two SRS resource sets for CB or nCB, and the two SRS resource sets include a first SRS resource set associated with a first UL TCI state and a second SRS resource set associated with a second UL TCI state, then, an SRS resource set indicator (SRSI) field contained in the DCI determines the scheduled PUSCH transmission is a single-panel/TRP PUSCH transmission or a multi-panel/TRP PUSCH transmission. If a field value of the SRSI field is ‘00’ or ‘01’, the scheduled PUSCH transmission is a single-panel/TRP PUSCH transmission. In particular, if the field value of the SRSI field is ‘00’, the first UL TCI state is applied to the scheduled PUSCH transmission, and if the field value of the SRSI field is ‘01’, the second UL TCI state is applied to the scheduled PUSCH transmission. If a field value of the SRSI field is ‘10’ or ‘11’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of the SRSI field is ‘10’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the SRSI field is ‘11’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the SRSI field is ‘10’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the SRSI field is ‘11’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the SRSI field is ‘10’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the SRSI field is ‘11’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then, a PUSCH scheme field contained in the DCI determines the scheduled PUSCH transmission is a single-panel/TRP PUSCH transmission or a multi-panel/TRP PUSCH transmission. If a field value of the PUSCH scheme field is ‘0’, the scheduled PUSCH transmission is a single-panel/TRP PUSCH transmission. In particular, if the field value of a 1-bit SRI field is ‘0’, the first UL TCI state is applied to the scheduled PUSCH transmission, and if the field value of the 1-bit SRI field is ‘1’, the second UL TCI state is applied to the scheduled PUSCH transmission. If a field value of the PUSCH scheme field is ‘1’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of a 1-bit SRI field is ‘0’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the 1-bit SRI field is ‘1’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the 1-bit SRI field is ‘0’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the 1-bit SRI field is ‘1’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the 1-bit SRI field is ‘0’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the 1-bit SRI field is ‘1’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then, an 8-bit SRI field contained in the DCI determines the scheduled PUSCH transmission is a single-panel/TRP PUSCH transmission or a multi-panel/TRP PUSCH transmission. If the SRS resource(s) indicated by the 8-bit SRI field are only from the first half or the second half, the scheduled PUSCH transmission is a single-panel/TRP PUSCH transmission. In particular, if the indicated SRS resource(s) are only from the first half, the first UL TCI state is applied to the scheduled PUSCH transmission, and if the indicated SRS resource(s) are only from the second half, the second UL TCI state is applied to the scheduled PUSCH transmission. If the SRS resources indicated by the 8-bit SRI field are from both the first half and the second half, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, (2) if the higher layer parameter is configured as is set as ‘sdmSchemeA’, then, the first UL TCI state is applied to a first PUSCH transmission occasion associated with the indicated SRS resource(s) from the first half, and the second UL TCI state is applied to a second PUSCH transmission occasion associated with the indicated SRS resource(s) from the second half, (3) if the ‘antenna port(s)’ field of the DCI indicates only DMRS port(s) within the first CDM group, and the higher layer parameter is configured as is set as ‘fdmSchemeA’, then, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and (4) if the ‘antenna port(s)’ field of the DCI indicates only DMRS port(s) within the first CDM group, the higher layer parameter is configured as is set as ‘fdmSchemeB’, then, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation.

FIG. 5 is a schematic block diagram illustrating apparatuses according to one embodiment.

Referring to FIG. 5, the UE (i.e. the remote unit) includes a processor, a memory, and a transceiver. The processor implements a function, a process, and/or a method which are proposed in FIG. 3.

The UE comprises a transceiver; and a processor coupled to the transceiver, wherein the processor is configured to receive, via the transceiver, a higher layer parameter to indicate the multi-panel/TRP PUSCH scheme, a configuration of one or two SRS resource sets for CB or nCB in a BWP of a cell, and a DCI scheduling a PUSCH transmission, wherein, the one or two SRS resource sets are associated with a first UL TCI state and a second UL TCI state; and determine UL TCI state(s) applied to the scheduled PUSCH transmission according to the higher layer parameter and fields contained in the DCI, depending on the configuration of one or two SRS resource sets for CB or nCB.

In some embodiment, if the configuration is two SRS resource sets for CB or nCB, and the two SRS resource sets include a first SRS resource set associated with a first UL TCI state and a second SRS resource set associated with a second UL TCI state, then, an SRS resource set indicator (SRSI) field contained in the DCI determines the scheduled PUSCH transmission is a single-panel/TRP PUSCH transmission or a multi-panel/TRP PUSCH transmission. If a field value of the SRSI field is ‘00’ or ‘01’, the scheduled PUSCH transmission is a single-panel/TRP PUSCH transmission. In particular, if the field value of the SRSI field is ‘00’, the first UL TCI state is applied to the scheduled PUSCH transmission, and if the field value of the SRSI field is ‘01’, the second UL TCI state is applied to the scheduled PUSCH transmission. If a field value of the SRSI field is ‘10’ or ‘11’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of the SRSI field is ‘10’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the SRSI field is ‘11’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the SRSI field is ‘10’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the SRSI field is ‘11’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the SRSI field is ‘10’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the SRSI field is ‘11’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then, a PUSCH scheme field contained in the DCI determines the scheduled PUSCH transmission is a single-panel/TRP PUSCH transmission or a multi-panel/TRP PUSCH transmission. If a field value of the PUSCH scheme field is ‘0’, the scheduled PUSCH transmission is a single-panel/TRP PUSCH transmission. In particular, if the field value of a 1-bit SRI field is ‘0’, the first UL TCI state is applied to the scheduled PUSCH transmission, and if the field value of the 1-bit SRI field is ‘1’, the second UL TCI state is applied to the scheduled PUSCH transmission. If a field value of the PUSCH scheme field is ‘1’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of a 1-bit SRI field is ‘0’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the 1-bit SRI field is ‘1’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the 1-bit SRI field is ‘0’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the 1-bit SRI field is ‘1’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the 1-bit SRI field is ‘0’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the 1-bit SRI field is ‘1’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then, an 8-bit SRI field contained in the DCI determines the scheduled PUSCH transmission is a single-panel/TRP PUSCH transmission or a multi-panel/TRP PUSCH transmission. If the SRS resource(s) indicated by the 8-bit SRI field are only from the first half or the second half, the scheduled PUSCH transmission is a single-panel/TRP PUSCH transmission. In particular, if the indicated SRS resource(s) are only from the first half, the first UL TCI state is applied to the scheduled PUSCH transmission, and if the indicated SRS resource(s) are only from the second half, the second UL TCI state is applied to the scheduled PUSCH transmission. If the SRS resources indicated by the 8-bit SRI field are from both the first half and the second half, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, (2) if the higher layer parameter is configured as is set as ‘sdmSchemeA’, then, the first UL TCI state is applied to a first PUSCH transmission occasion associated with the indicated SRS resource(s) from the first half, and the second UL TCI state is applied to a second PUSCH transmission occasion associated with the indicated SRS resource(s) from the second half, (3) if the ‘antenna port(s)’ field of the DCI indicates only DMRS port(s) within the first CDM group, and the higher layer parameter is configured as is set as ‘fdmSchemeA’, then, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and (4) if the ‘antenna port(s)’ field of the DCI indicates only DMRS port(s) within the first CDM group, the higher layer parameter is configured as is set as ‘fdmSchemeB’, then, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation.

The gNB (i.e. the base unit) includes a processor, a memory, and a transceiver. The processor implements a function, a process, and/or a method which are proposed in FIG. 4.

The base unit comprises a transceiver; and a processor coupled to the transceiver, wherein the processor is configured to transmit, via the transceiver, a higher layer parameter to indicate the multi-panel/TRP PUSCH scheme and a configuration of one or two SRS resource sets for CB or nCB, wherein, the one or two SRS resource sets are associated with a first UL TCI state and a second UL TCI state; determine UL TCI state(s) applied to a PUSCH transmission according to the preconfigured higher layer parameter, depending on the configuration; and transmit, via the transceiver, a DCI scheduling the PUSCH transmission, wherein, the DCI contains fields for indicating the determined UL TCI state(s).

In some embodiment, if the configuration is two SRS resource sets for CB or nCB, and the two SRS resource sets include a first SRS resource set associated with a first UL TCI state and a second SRS resource set associated with a second UL TCI state, then, an SRS resource set indicator (SRSI) field contained in the DCI determines the scheduled PUSCH transmission is a single-panel/TRP PUSCH transmission or a multi-panel/TRP PUSCH transmission. If a field value of the SRSI field is ‘00’ or ‘01’, the scheduled PUSCH transmission is a single-panel/TRP PUSCH transmission. In particular, if the field value of the SRSI field is ‘00’, the first UL TCI state is applied to the scheduled PUSCH transmission, and if the field value of the SRSI field is ‘01’, the second UL TCI state is applied to the scheduled PUSCH transmission. If a field value of the SRSI field is ‘10’ or ‘11’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of the SRSI field is ‘10’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the SRSI field is ‘11’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the SRSI field is ‘10’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the SRSI field is ‘11’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the SRSI field is ‘10’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the SRSI field is ‘11’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then, a PUSCH scheme field contained in the DCI determines the scheduled PUSCH transmission is a single-panel/TRP PUSCH transmission or a multi-panel/TRP PUSCH transmission. If a field value of the PUSCH scheme field is ‘0’, the scheduled PUSCH transmission is a single-panel/TRP PUSCH transmission. In particular, if the field value of a 1-bit SRI field is ‘0’, the first UL TCI state is applied to the scheduled PUSCH transmission, and if the field value of the 1-bit SRI field is ‘1’, the second UL TCI state is applied to the scheduled PUSCH transmission. If a field value of the PUSCH scheme field is ‘1’, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, if the field value of a 1-bit SRI field is ‘0’, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, and if the field value of the 1-bit SRI field is ‘1’, the first UL TCI state is applied to the PUSCH layer(s) of the scheduled PUSCH transmission each of which is associated with an indicated DMRS port within the second CDM group, and the second UL TCI state is applied to the PUSCH layer(s) of the scheduled PUSCH transmission each of which is associated with an indicated DMRS port within the first CDM group, (2) if the higher layer parameter is configured as is set as ‘sdmSchemeA’, then, both the first UL TCI state and the second UL TCI state are applied to the scheduled PUSCH transmission, (3) if the ‘antenna port(s)’ field of the DCI indicates only DMRS port(s) within the first CDM group, and the higher layer parameter is configured as is set as ‘fdmSchemeA’, then, if the field value of the 1-bit SRI field is ‘0’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and if the field value of the 1-bit SRI field is ‘1’, the first UL TCI state is applied to the second frequency domain resource allocation of the scheduled PUSCH transmission, and the second UL TCI state is applied to the first frequency domain resource allocation of the scheduled PUSCH transmission, and (4) if the ‘antenna port(s)’ field of the DCI indicates only DMRS port(s) within the first CDM group, and the higher layer parameter is configured as is set as ‘fdmSchemeB’, then, if the field value of the 1-bit SRI field is ‘0’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and if the field value of the 1-bit SRI field is ‘1’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

In some embodiment, if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then, an 8-bit SRI field contained in the DCI determines the scheduled PUSCH transmission is a single-panel/TRP PUSCH transmission or a multi-panel/TRP PUSCH transmission. If the SRS resource(s) indicated by the 8-bit SRI field are only from the first half or the second half, the scheduled PUSCH transmission is a single-panel/TRP PUSCH transmission. In particular, if the indicated SRS resource(s) are only from the first half, the first UL TCI state is applied to the scheduled PUSCH transmission, and if the indicated SRS resource(s) are only from the second half, the second UL TCI state is applied to the scheduled PUSCH transmission. If the SRS resources indicated by the 8-bit SRI field are from both the first half and the second half, the scheduled PUSCH transmission is a multi-panel/TRP PUSCH transmission. In particular, (1) if an ‘antenna port(s)’ field of the DCI indicates DMRS port(s) within a first CDM group and DMRS port(s) within a second CDM group, and the higher layer parameter is not configured or is configured as is set as ‘fdmSchemeA’ or ‘fdmSchemeB’, then, the first UL TCI state is applied to the PUSCH layer(s) of the scheduled PUSCH transmission each of which is associated with an indicated DMRS port within the first CDM group, and the second UL TCI state is applied to the PUSCH layer(s) of the scheduled PUSCH transmission each of which is associated with an indicated DMRS port within the second CDM group, (2) if the higher layer parameter is configured as is set as ‘sdmSchemeA’, then, the first UL TCI state is applied to a first PUSCH transmission occasion associated with the indicated SRS resource(s) from the first half, and the second UL TCI state is applied to a second PUSCH transmission occasion associated with the indicated SRS resource(s) from the second half, (3) if the ‘antenna port(s)’ field of the DCI indicates only DMRS port(s) within the first CDM group, and the higher layer parameter is configured as is set as ‘fdmSchemeA’, then, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and (4) if the ‘antenna port(s)’ field of the DCI indicates only DMRS port(s) within the first CDM group, the higher layer parameter is configured as is set as ‘fdmSchemeB’, then, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a higher layer parameter to indicate a multi-panel/transmission reception point (TRP) physical uplink shared channel (PUSCH) scheme, a configuration of one or two sounding reference signal (SRS) resource sets for codebook (CB) or non-codebook (nCB) in a band width part (BWP) of a cell, and a downlink control information (DCI) scheduling a PUSCH transmission, wherein the one or two SRS resource sets are associated with a first uplink (UL) transmission configuration indicator (TCI) state and a second UL TCI state; and
determine one or more UL TCI states applied to the scheduled PUSCH transmission according to the higher layer parameter and one or more fields contained in the DCI, depending on the configuration of one or two SRS resource sets for CB or nCB.

2. The UE of claim 1, wherein
if the configuration is two SRS resource sets for CB or nCB, and the two SRS resource sets include a first SRS resource set associated with a first UL TCI state and a second SRS resource set associated with a second UL TCI state, then,
an SRS resource set indicator (SRSI) field contained in the DCI determines the scheduled PUSCH transmission is a single-panel/TRP PUSCH transmission or a multi-panel/TRP PUSCH transmission.

3. The UE of claim 2, wherein
if a field value of the SRSI field is ‘00’ or ‘01’, the scheduled PUSCH transmission is a single-panel/TRP PUSCH transmission; and
if the field value of the SRSI field is ‘10’ or ‘11’, the scheduled PUSCH transmission is a multi-panel/TRP PUSCH transmission.

4. The UE of claim 3, wherein
if the field value of the SRSI field is ‘00’, the first UL TCI state is applied to the scheduled PUSCH transmission, and
if the field value of the SRSI field is ‘01’, the second UL TCI state is applied to the scheduled PUSCH transmission.

5. The UE of claim 3, wherein,
if an ‘antenna port(s)’ field of the DCI indicates one or more demodulation reference signal (DMRS) ports within a first code division multiplexing (CDM) group and one or more DMRS ports within a second CDM group, and the higher layer parameter is not configured or is configured and is set as ‘fdmSchemeA’ or ‘fdmSchemeB’, then,
if the field value of the SRSI field is ‘10’, the first UL TCI state is applied to one or more PUSCH layers of the scheduled PUSCH transmission each of which is associated with an indicated DMRS port within the first CDM group, and the second UL TCI state is applied to one or more PUSCH layers of the scheduled PUSCH transmission each of which is associated with an indicated DMRS port within the second CDM group, and
if the field value of the SRSI field is ‘11’, the first UL TCI state is applied to the one or more PUSCH layers of the scheduled PUSCH transmission each of which is associated with the indicated DMRS port within the second CDM group, and the second UL TCI state is applied to the one or more PUSCH layers of the scheduled PUSCH transmission each of which is associated with the indicated DMRS port within the first CDM group,
if the higher layer parameter is configured and is set as ‘sdmSchemeA’, then, both the first UL TCI state and the second UL TCI state are applied to the scheduled PUSCH transmission,
if the ‘antenna port(s)’ field of the DCI indicates only one or more DMRS ports within the first CDM group, and the higher layer parameter is configured and is set as ‘fdmSchemeA’, then,
if the field value of the SRSI field is ‘10’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and
if the field value of the SRSI field is ‘11’, the first UL TCI state is applied to the second frequency domain resource allocation of the scheduled PUSCH transmission, and the second UL TCI state is applied to the first frequency domain resource allocation of the scheduled PUSCH transmission, and
if the ‘antenna port(s)’ field of the DCI indicates only one or more DMRS ports within the first CDM group, and the higher layer parameter is configured and is set as ‘fdmSchemeB’, then,
if the field value of the SRSI field is ‘10’, the first UL TCI state is applied to a first PUSCH transmission occasion of the scheduled PUSCH transmission associated with the first frequency domain resource allocation, and the second UL TCI state is applied to a second PUSCH transmission occasion of the scheduled PUSCH transmission associated with the second frequency domain resource allocation that is not overlapped with the first frequency domain resource allocation, and
if the field value of the SRSI field is ‘11’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

6. The UE of claim 1, wherein
if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then,
a PUSCH scheme field contained in the DCI determines the scheduled PUSCH transmission is a single-panel/TRP PUSCH transmission or a multi-panel/TRP PUSCH transmission.

7. The UE of claim 6, wherein
if a field value of the PUSCH scheme field is ‘0’, the scheduled PUSCH transmission is a single-panel/TRP PUSCH transmission; and
if the field value of the PUSCH scheme field is ‘1’, the scheduled PUSCH transmission is a multi-panel/TRP PUSCH transmission.

8. The UE of claim 7, wherein
if a field value of a 1-bit SRS resource indicator (SRI) field is ‘0’, the first UL TCI state is applied to the scheduled PUSCH transmission, and
if the field value of the 1-bit SRI field is ‘1’, the second UL TCI state is applied to the scheduled PUSCH transmission.

9. The UE of claim 7, wherein
if an ‘antenna port(s)’ field of the DCI indicates one or more demodulation reference signal (DMRS) ports within a first code division multiplexing (CDM) group and one or more DMRS ports within a second CDM group, and the higher layer parameter is not configured or is configured and is set as ‘fdmSchemeA’ or ‘fdmSchemeB’, then,
if a field value of a 1-bit SRS resource indicator (SRI) field is ‘0’, the first UL TCI state is applied to one or more PUSCH layers of the scheduled PUSCH transmission each of which is associated with an indicated DMRS port within the first CDM group, and the second UL TCI state is applied to the one or more PUSCH layers of the scheduled PUSCH transmission each of which is associated with an indicated DMRS port within the second CDM group, and
if the field value of the 1-bit SRI field is ‘1’, the first UL TCI state is applied to the one or more PUSCH layers of the scheduled PUSCH transmission each of which is associated with an indicated DMRS port within the second CDM group, and the second UL TCI state is applied to the one or more PUSCH layers of the scheduled PUSCH transmission each of which is associated with an indicated DMRS port within the first CDM group,
if the higher layer parameter is configured and is set as ‘sdmSchemeA’, then, both the first UL TCI state and the second UL TCI state are applied to the scheduled PUSCH transmission,
if the ‘antenna port(s)’ field of the DCI indicates only one or more DMRS ports within the first CDM group, and the higher layer parameter is configured and is set as ‘fdmSchemeA’, then,
if the field value of the 1-bit SRI field is ‘0’, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and
if the field value of the 1-bit SRI field is ‘1’, the first UL TCI state is applied to the second frequency domain resource allocation of the scheduled PUSCH transmission, and the second UL TCI state is applied to the first frequency domain resource allocation of the scheduled PUSCH transmission, and
if the ‘antenna port(s)’ field of the DCI indicates only one or more DMRS ports within the first CDM group, and the higher layer parameter is configured and is set as ‘fdmSchemeB’, then,
if the field value of the 1-bit SRI field is ‘0’, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation, and
if the field value of the 1-bit SRI field is ‘1’, the first UL TCI state is applied to the second PUSCH transmission occasion of the scheduled PUSCH transmission associated with the second frequency domain resource allocation, and the second UL TCI state is applied to the first PUSCH transmission occasion of the scheduled PUSCH transmission associated with the first frequency domain resource allocation.

10. The UE of claim 1, wherein
if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then,
an 8-bit SRS resource indicator (SRI) field contained in the DCI determines the scheduled PUSCH transmission is a single-panel/TRP PUSCH transmission or a multi-panel/TRP PUSCH transmission.

11. The UE of claim 10, wherein
if the one or more SRS resources indicated by the 8-bit SRI field are only from the first half or the second half, the scheduled PUSCH transmission is a single-panel/TRP PUSCH transmission; and
if the one or more SRS resources indicated by the 8-bit SRI field are from both the first half and the second half, the scheduled PUSCH transmission is a multi-panel/TRP PUSCH transmission.

12. The UE of claim 11, wherein
if the indicated one or more SRS resources are only from the first half, the first UL TCI state is applied to the scheduled PUSCH transmission, and
if the indicated one or more SRS resources are only from the second half, the second UL TCI state is applied to the scheduled PUSCH transmission.

13. The UE of claim 11, wherein
if an ‘antenna port(s)’ field of the DCI indicates one or more demodulation reference signal (DMRS) ports within a first code division multiplexing (CDM) group and one or more DMRS ports within a second CDM group, and the higher layer parameter is not configured or is configured and is set as ‘fdmSchemeA’ or ‘fdmSchemeB’, then, the first UL TCI state is applied to the one or more PUSCH layers of the scheduled PUSCH transmission each of which is associated with an indicated DMRS port within the first CDM group, and the second UL TCI state is applied to the one or more PUSCH layers of the scheduled PUSCH transmission each of which is associated with an indicated DMRS port within the second CDM group,
if the higher layer parameter is configured and is set as ‘sdmSchemeA’, then, the first UL TCI state is applied to a first PUSCH transmission occasion associated with the indicated one or more SRS resources from the first half, and the second UL TCI state is applied to a second PUSCH transmission occasion associated with the indicated one or more SRS resources from the second half,
if the ‘antenna port(s)’ field of the DCI indicates only one or more DMRS ports within the first CDM group, and the higher layer parameter is configured and is set as ‘fdmSchemeA’, then, the first UL TCI state is applied to a first frequency domain resource allocation of the scheduled PUSCH transmission, and the second UL TCI state is applied to a second frequency domain resource allocation that is not overlapped with the first frequency domain resource allocation of the scheduled PUSCH transmission, and
if the ‘antenna port(s)’ field of the DCI indicates only one or more DMRS ports within the first CDM group, the higher layer parameter is configured and is set as ‘fdmSchemeB’, then, the first UL TCI state is applied to a first PUSCH transmission occasion of the scheduled PUSCH transmission associated with a first frequency domain resource allocation, and the second UL TCI state is applied to a second PUSCH transmission occasion of the scheduled PUSCH transmission associated with a second frequency domain resource allocation that is not overlapped with the first frequency domain resource allocation.

14. A method performed by a user equipment (UE), the method comprising:
receiving a higher layer parameter to indicate a multi-panel/transmission reception point (TRP) physical uplink shared channel (PUSCH) scheme, a configuration of one or two sounding reference signal (SRS) resource sets for codebook (CB) or non-codebook (nCB) in a band width part (BWP) of a cell, and a downlink control information (DCI) scheduling a PUSCH transmission, wherein the one or two SRS resource sets are associated with a first uplink (UL) transmission configuration indicator (TCI) state and a second UL TCI state; and
determine one or more UL TCI states applied to the scheduled PUSCH transmission according to the higher layer parameter and one or more fields contain in the DCI, depending on the configuration of one or two SRS resource sets for CB or nCB.

15. A base station for wireless communication, comprising:
at least one memory; and
at least one processor coupled with the at least one memory and configured to cause the base station to:
transmit a higher layer parameter to indicate a multi-panel/transmission reception point (TRP) physical uplink shared channel (PUSCH) scheme and a configuration of one or two sounding reference signal (SRS) resource sets for codebook (CB) or non-codebook (nCB), wherein the one or two SRS resource sets are associated with a first uplink (UL) transmission configuration indicator (TCI) state and a second UL TCI state;
determine one or more UL TCI states applied to a PUSCH transmission according to the higher layer parameter, depending on the configuration; and
transmit a downlink control information (DCI) scheduling the PUSCH transmission, wherein the DCI contains fields for indicating the determined one or more UL TCI states.

16. A processor for wireless communication, comprising:
at least one controller coupled with at least one memory and configured to cause the processor to:
receive a higher layer parameter to indicate a multi-panel/transmission reception point (TRP) physical uplink shared channel (PUSCH) scheme, a configuration of one or two sounding reference signal (SRS) resource sets for codebook (CB) or non-codebook (nCB) in a band width part (BWP) of a cell, and a downlink control information (DCI) scheduling a PUSCH transmission, wherein the one or two SRS resource sets are associated with a first uplink (UL) transmission configuration indicator (TCI) state and a second UL TCI state; and
determine one or more UL TCI states applied to the scheduled PUSCH transmission according to the higher layer parameter and one or more fields contained in the DCI, depending on the configuration of one or two SRS resource sets for CB or nCB.

17. The processor of claim 16, wherein
if the configuration is two SRS resource sets for CB or nCB, and the two SRS resource sets include a first SRS resource set associated with a first UL TCI state and a second SRS resource set associated with a second UL TCI state, then,
an SRS resource set indicator (SRSI) field contained in the DCI determines the scheduled PUSCH transmission is a single-panel/TRP PUSCH transmission or a multi-panel/TRP PUSCH transmission.

18. The processor of claim 17, wherein
if a field value of the SRSI field is ‘00’ or ‘01’, the scheduled PUSCH transmission is a single-panel/TRP PUSCH transmission; and
if the field value of the SRSI field is ‘10’ or ‘11’, the scheduled PUSCH transmission is a multi-panel/TRP PUSCH transmission.

19. The processor of claim 16, wherein
if the configuration is one SRS resource set for CB and the one SRS resource set includes a first SRS resource associated with the first UL TCI state and a second SRS resource associated with the second UL TCI state or includes first two SRS resources associated with the first UL TCI state and last two SRS resources associated with the second UL TCI state, then,
a PUSCH scheme field contained in the DCI determines the scheduled PUSCH transmission is a single-panel/TRP PUSCH transmission or a multi-panel/TRP PUSCH transmission.

20. The processor of claim 16, wherein
if the configuration is one SRS resource set for nCB, the one SRS resource set includes up to 8 SRS resources, and a first half of the up to 8 SRS resources is associated with the first UL TCI state and a second half of the up to 8 SRS resources is associated with the second UL TCI state, then,
an 8-bit SRS resource indicator (SRI) field contained in the DCI determines the scheduled PUSCH transmission is a single-panel/TRP PUSCH transmission or a multi-panel/TRP PUSCH transmission.
